(19) United States
(12) Patent Application Publication
(10) Pub. No.: US 2025/0044595 A1
(43) Pub. Date: Feb. 6, 2025

(54) OPTICAL WAVEGUIDE WITH MULTIPLE OPTICAL PATHS

(71) Applicant: GOOGLE LLC, Mountain View, CA (US)

(72) Inventor: Joseph Daniel Lowney, Tucson, AZ (US)

(21) Appl. No.: 18/720,252

(22) PCT Filed: Nov. 22, 2022
(86) PCT No.: PCT/US2022/050730

§ 371 Date: Jun. 14, 2024

Related U.S. Application Data
(60) Provisional application No. 63/290,114, filed on Dec. 16, 2021.

(51) Int. Cl. G02B 27/01; G02B 27/00; G02B 27/10

(52) U.S. Cl. CPC G02B 27/0172; G02B 27/0081; G02B 27/1086; G02B 2027/0147; G02B 2027/0178

(57) ABSTRACT

Systems and methods are provided involving a waveguide comprising an incoupler and an outcoupler. The incoupler is configured to receive display light representative of an image for display, and to direct a first portion of the display light to propagate within the waveguide along a first optical path and a second portion of the display light to propagate within the waveguide along a second optical path, such that the first optical path and the second optical path have substantially non-overlapping propagation angles. The outcoupler is configured to combine the first portion of the display light and the second portion of the display light to display a representation of the image.

### BACKGROUND

Some display systems employ a projector, which is an optical device that projects or shines a pattern of light onto another object (e.g., onto a surface of another object, such as onto a projection screen or retina) in order to display an image or video on or via that other object. In conventional projection systems, light is temporally modulated to provide a pattern of light, which is spatially distributed over a two-dimensional display area. The spatial distribution of the modulated pattern of light produces an image at the display area.

### BRIEF SUMMARY OF EMBODIMENTS

In an embodiment, a waveguide comprises an incoupler configured to receive display light representative of an image for display, and an outcoupler. The incoupler is configured to direct a first portion of the display light to propagate within the waveguide along a first optical path and a second portion of the display light to propagate within the waveguide along a second optical path, wherein the first optical path and the second optical path have substantially non-overlapping propagation angles; the outcoupler is configured to combine the first portion of the display light and the second portion of the display light to display a representation of the image.

The first portion of the display light may correspond to a first spatial portion of the image, and the second portion of the display light may correspond to a second spatial portion of the image. The first spatial portion of the image and the second spatial portion of the image may partially overlap.

The first portion of the display light may comprise a first set of wavelengths, such that the second portion of the display light comprises a second set of wavelengths that is distinct from the first set.

The waveguide may comprise a first exit pupil expander disposed in the first optical path and configured to redirect the first portion of the display light toward the outcoupler, and a second exit pupil expander disposed in the first optical path and configured to redirect the second portion of the display light toward the outcoupler.

The outcoupler may be configured to combine the first portion of the display light and the second portion of the display light to display the representation.

The incoupler may further be configured to receive the display light from an optical engine; to divide the display light into at least the first portion of the display light and the second portion of the display light; to redirect the first portion of the display light to propagate within the waveguide along the first optical path; and to redirect the second portion of the display light to propagate within the waveguide along the second optical path. The incoupler may further be configured to divide the display light into a third portion of the display light, and to direct the third portion of the display light to propagate along a third optical path that is distinct from the first optical path and the second optical path. The representation may be a combination of the first portion of the image, the second portion of the image, and the third portion of the image.

In an embodiment, a method comprises receiving display light representative of an image for display; directing a first portion of the display light to propagate within a waveguide along a first optical path and a second portion of the display light to propagate within the waveguide along a second optical path, the first optical path and the second optical path having respectively non-overlapping propagation angles; and combining the first portion of the display light and the second portion of the display light to display a representation of the image.

The first portion of the display light may convey a first spatial portion of the image, such that the second portion of the display light conveys a second spatial portion of the image. The first spatial portion of the image and the second spatial portion of the image may partially overlap.

Directing the first portion of the display light along the first optical path may include directing a first set of wavelengths of the display light along the first optical path, such that directing the second portion of the display light along the second optical path includes directing a second set of wavelengths of the display light along the second optical path, and such that the second set of wavelengths is distinct from the first set.

The method may further comprise redirecting the first portion of the display light toward an outcoupler of the waveguide with a first exit pupil expander disposed in the first optical path; and redirecting the second portion of the display light toward the outcoupler with a second exit pupil expander disposed in the second optical path. The method may further comprise combining, with the outcoupler, the first portion of the display light and the second portion of the display light to display the representation.

The method may further comprise receiving, with an incoupler of the waveguide, the display light from an optical engine; dividing, by the incoupler, the display light into at least the first portion of the display light and the second portion of the display light; redirecting, by the incoupler, the first portion of the display light to propagate within the waveguide along the first optical path; and redirecting, by the incoupler, the second portion of the display light to propagate within the waveguide along the second optical path.

The method may further comprise dividing the display light into a third portion and directing the third portion of the display light to propagate along a third optical path that is distinct from the first optical path and the second optical path. The method may still further comprise displaying the representation by combining the first portion of the display light, the second portion of the display light, and the third portion of the display light.

In an embodiment, a projection system comprises an optical engine and a waveguide, such that the waveguide is configured to receive display light representative of an image for display; to direct a first portion of the display light to propagate within the waveguide along a first optical path and a second portion of the display light to propagate within the waveguide along a second optical path, wherein the first optical path and the second optical path have respectively non-overlapping propagation angles; and to combine the first portion of the display light and the second portion of the display light to display a representation of the image. The waveguide may be further configured to divide the display light into a third portion, and to direct the third portion of the display light to propagate along a third optical path that is distinct from the first optical path and the second optical path.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a display system having an integrated laser projector, in accordance with some embodiments.

FIG. 2 is a diagram illustrating a partially transparent view of a display system that includes a projection system, in accordance with some embodiments.

FIG. 3 is a diagram illustrating an isometric view of a waveguide having an incoupler, an outcoupler, and an exit pupil expander.

FIG. 4 is a chart illustrating the propagation of display light through the waveguide of FIG. 3 with respect to k-space.

FIG. 5 is a diagram illustrating an isometric view of a waveguide having an incoupler, an outcoupler, two exit pupil expanders disposed at opposite sides of the incoupler, where the waveguide is configured to propagate light along two optical paths, in accordance with some embodiments.

FIG. 6 is a chart illustrating the propagation of display light through the waveguide of FIG. 4 with respect to k-space, in accordance with some embodiments.

FIG. 7 is a diagram illustrating an isometric view of a waveguide having an incoupler, an outcoupler, and two exit pupil expanders, where the waveguide is configured to propagate light along two optical paths and the incoupler is configured to redirect first and second portions of display light along first and second optical paths toward the exit pupil expanders to shift corresponding images in both the kₓ and k_{y} dimensions, in accordance with some embodiments.

FIG. 8 is a chart illustrating the propagation of display light through the waveguide of FIG. 7 with respect to k-space, in accordance with some embodiments.

FIG. 9 illustrating an isometric view of a waveguide having an incoupler, an outcoupler, two exit pupil expanders disposed at opposite sides of the incoupler, where the waveguide is configured to propagate display light along three optical paths, in accordance with some embodiments.

FIG. 10 is a chart illustrating the propagation of display light through the waveguide of FIG. 9 with respect to k-space, in accordance with some embodiments.

### DETAILED DESCRIPTION

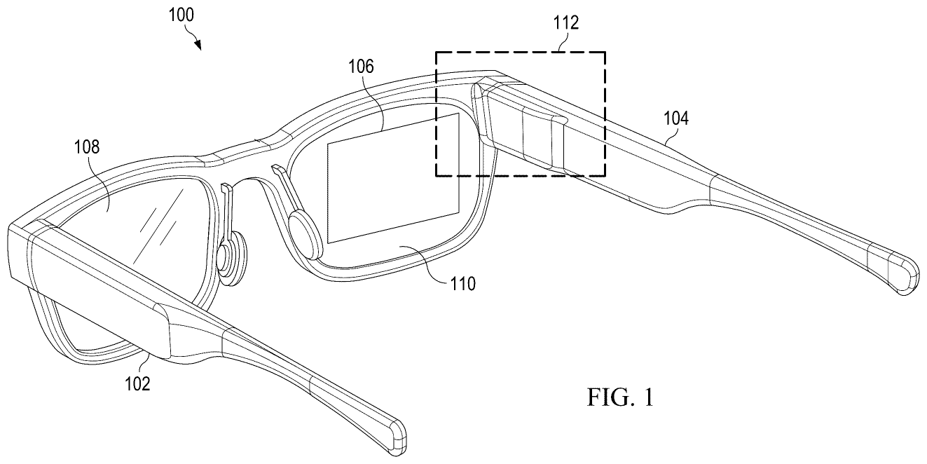

FIGS. 1-10 illustrate embodiments for compactly arranging a near-eye display system (e.g., a wearable heads-up display (WHUD)) or other display system while increasing the spatial or angular resolution of a displayed image. It will be appreciated that while particular embodiments discussed herein involve utilizing optical or other components as part of a wearable display device, additional embodiments may utilize such components via various other types of devices in accordance with techniques described herein.

In accordance with the embodiments described herein, the projection system of a display system includes a waveguide that causes received display light to propagate along multiple optical paths between an incoupler of the waveguide and an outcoupler of the waveguide. The optical paths along which the waveguide causes the received display light to propagate correspond to respectively different positions in k-space (with k being the reciprocal of wavelength, such that k=1/λ), such that the propagation angles for each optical path differ. Light is only able to propagate through the waveguide via total internal reflection (TIR) at a limited number of discrete propagation angles (i.e., polar angles), such that only a portion of each image conveyed via the display light is able to successfully propagate through the waveguide to be output to the eye of a user. In some embodiments, at least a portion of the different optical paths through the waveguide have non-overlapping propagation angles, thereby allowing a respectively different portion of each image to be successfully conveyed via the waveguide. In certain embodiments, the waveguide is configured to cause light to propagate along different optical paths with respectively different (non-overlapping) propagation angles, such that a density of optical modes utilized by image-conveying display light as it propagates through the waveguide and the spatial or angular resolution of the images output by the waveguide are increased when compared to corresponding aspects of conventional waveguides that provide single optical paths or multiple optical paths that have similar or substantially overlapping propagation angles. As used herein, an optical mode is a set of guided optical propagation paths through the waveguide for wavelengths of the image-conveying display light.

In some embodiments, the waveguide includes a first exit pupil expander and a second exit pupil expander, each disposed at opposite sides of the incoupler of the waveguide. Display light corresponding to an original image for display is received at an incoupler of the waveguide. The waveguide is configured to cause a first portion of the display light to propagate along a first optical path that includes the first exit pupil expander and to cause a second portion of the display light to propagate along a second optical path that includes the second exit pupil expander. For example, the incoupler is configured to redirect the first portion of the display light toward the first exit pupil expander (causing a first image conveyed by or otherwise corresponding to the first portion of the display light to be shifted in the positive k_{y} dimension, with respect to k-space) and to redirect the second portion of received display light toward the second exit pupil expander (causing a second image conveyed by or otherwise corresponding to the second portion of the display light to be shifted in the negative k_{y} dimension, with respect to k-space). It will be appreciated that as discussed herein, subsequent representations of the original image or portions thereof based on transformations or redirection of the display light may be referred to herein as images themselves.

The first exit pupil expander is configured to redirect the first portion of the display light toward the outcoupler of the waveguide (causing the first image conveyed by the first portion of the display light to be shifted in the negative kₓ dimension and the negative k_{y} dimension, with respect to k-space). The second exit pupil expander is configured to redirect the second portion of the display light toward the outcoupler of the waveguide (causing the second image conveyed by the second portion of the display light to be shifted in the negative kₓ dimension and the positive k_{y} dimension, with respect to k-space). The outcoupler is configured to output the first and second portions of the display light toward the eye of a user at an angle that is the same or substantially similar (e.g., within about 5%) to the angle at which the display light was input at the incoupler (causing the first and second images conveyed by the first and second portions of the display light to be shifted in the positive kₓ dimension, with respect to k-space). The first and second images are combined at the outcoupler to form a final image. The final image includes first portions of the original image and second portions of the original image, where the first portions of the original image correspond to and are conveyed via the first portion of display light along the first optical path and the second portions correspond to and are conveyed via the second portion of display light along the second optical path.

In some embodiments, the first portion of the original image that is conveyed by the first portion of display light that successfully propagates through the waveguide via TIR along the first optical path is different from (e.g., at least partially spatially distinct with respect to) the second portion of the original image that is conveyed by the second portion of display light that successfully propagates through the waveguide via TIR along the second optical path. In some embodiments, the first portion of the display light that conveys the first image utilizes a first set of optical modes and the second portion of the display light that conveys the second image utilizes a second set of optical modes, and the first portion of the display light and the second portion of the display light traverse spatially distinct paths. The first set of optical modes and the second set of optical modes are respectively non-overlapping, or partially non-overlapping, with each of the first and second sets of optical modes corresponding to respectively different portions of the original image. In this way, the density of optical modes utilized to convey the final representation is increased, compared to the density of optical modes utilized to convey the first or second images alone (e.g., compared to a waveguide that only includes one of the first or second optical paths). By causing the first and second portions of the display light to propagate via two different, spatially distinct paths, the spatial or angular resolution of the final image is increased.

In some embodiments, the first image and the second image are each a representation of the original image presented for display. In some embodiments, the first image corresponds to a first spatial portion of the original image, and the second image corresponds to a second spatial portion of the original image. In certain embodiments, the first and second portions of the original image partially overlap. In some embodiments, the first image corresponds to a first representation of the original image that includes only a first set of wavelengths of light (i.e., colors) of the original image, the second image corresponds to a second representation of the original image that includes only a second set of wavelengths of light (i.e., colors) of the original image, and the first set of wavelengths of light is at least partially different from the second set of wavelengths of light.

In some embodiments, the incoupler is further configured to redirect a third portion of the display light conveying a third image along a third optical path from the incoupler toward the outcoupler via TIR, without the third portion of the display light being incident on an intervening exit pupil expander. The third image is combined with the first and second images to form the final image output by the waveguide via the outcoupler. By redirecting the third portion of the display light from the incoupler to the outcoupler via TIR without intervening redirection (e.g., by an exit pupil expander), the third image is only shifted along the kₓ dimension, which causes entire continuous ranges of viewing angles (corresponding to arcs defined by discrete angles of propagation for which TIR is enabled in the waveguide) to be included in the final image, thereby increasing the density of optical modes utilized in the waveguide and increasing the spatial or angular resolution of the final image. In some embodiments, the third image only corresponds to a portion of the original image and results in an increase in the spatial or angular resolution of only a portion of the final image, since the geometry of the third image is not increased by an exit pupil expander in the same way as the geometries of the first and second images are increased by the first and second image pupil expanders. In some embodiments, the propagation length along the third optical path is shorter than either of the propagation lengths along the first and second optical paths, such that the third portion of the display light that propagates along the third optical path undergoes less scattering (e.g., due to surface or bulk material features or non-idealities) than the first and second portions of the display light that propagate along the first and second optical paths, which further enhances the respective spatial or angular resolutions of the third image and the corresponding portion of the final image. In some embodiments, such an arrangement enhances the spatial or angular resolution of a targeted region of the field of view (FOV) of the display device, corresponding to a portion of the final image output by the waveguide.

In some embodiments, the waveguide includes a first exit pupil expander and a second exit pupil expander, where the incoupler is configured to redirect first and second portions of display light toward the first and second exit pupil expanders, respectively, such that corresponding first and second images conveyed by the first and second portions of display light are each shifted in both the kₓ and k_{y} dimensions with respect to k-space. Light carrying an original image is received at the incoupler of the waveguide. The waveguide is configured to propagate a first portion of the display light along a first optical path that includes the first exit pupil expander and to propagate a second portion of the display light along a second optical path that includes the second exit pupil expander. For example, the incoupler is configured to redirect the first portion of the display light toward the first exit pupil expander (causing a first image conveyed by the first portion of the display light to be shifted in the positive k_{y} dimension and the negative kₓ dimension, with respect to k-space) and to redirect the second portion of received display light toward the second exit pupil expander (causing a second image conveyed by the second portion of the display light to be shifted in the negative k_{y} dimension and the negative kₓ dimension, with respect to k-space). The first exit pupil expander is configured to redirect the first portion of the display light toward the outcoupler of the waveguide (causing the first image conveyed by the first portion of the display light to be shifted in the negative kₓ dimension and the negative k_{y} dimension, with respect to k-space). The second exit pupil expander is configured to redirect the second portion of the display light toward the outcoupler of the waveguide (causing the second image conveyed by the second portion of the display light to be shifted in the negative kₓ dimension and the positive k_{y} dimension, with respect to k-space). The outcoupler is configured to output the first and second portions of the display light toward the eye of a user at an angle that is the same or substantially similar (e.g., within about 5%) to the angle at which the display light was input at the incoupler (causing the first and second images conveyed by the first and second portions of the display light to be shifted in the positive kₓ dimension, with respect to k-space). In some embodiments, the first image and the second image are each a representation of the original image. In some embodiments, the first image corresponds to a first spatial portion of the original image and the second image corresponds to a second spatial portion of the original image. In certain embodiments, the first and second spatial portions of the original image partially overlap. In some embodiments, the first image corresponds to a first representation of the original image that includes only a first set of wavelengths of light (i.e., colors) of the original image, the second image corresponds to a second representation of the original image that includes only a second set of wavelengths of light (i.e., colors) of the original image, and the first set of wavelengths of light is different from the second set of wavelengths of light.

The first and second images are combined at the outcoupler to form a final image that includes first portions and second portions of the original image, where the first portions of the original image are conveyed via the first portion of display light that conveys the first image via the first optical path and the second portions are conveyed via the second portion of display light that conveys the second image via the second optical path. The first portion of the original image that is conveyed by the first portion of display light that successfully propagates through the waveguide via TIR along the first optical path is different from (at least partially spatially distinct with respect to) the second portion of the original image that is conveyed by the second portion of display light that successfully propagates through the waveguide via TIR along the second optical path. In some embodiments, the first portion of the display light that conveys the first image utilizes a first set of optical modes and the second portion of the display light that conveys the second image utilizes a second set of optical modes, and the first portion of the display light and the second portion of the display light traverse spatially distinct paths. That is, the first set of optical modes and the second set of optical modes are respectively non-overlapping or partially non-overlapping, with each of the first and second sets of optical modes corresponding to respectively different portions of the original image. In this way, the density of optical modes of utilized to convey the final image are increased, compared to that of the optical modes utilized to convey the first image alone or those utilized to convey the second image alone (e.g., compared to a waveguide that only includes one of the first or second optical paths). By causing the first and second portions of the display light via two different, spatially distinct paths, the spatial or angular resolution of the final image is increased. By shifting the first and second images in both the kₓ and k_{y} dimensions (rather than only the k_{y} dimension) upon redirection of the first and second portions of display light by the incoupler, the efficiency, uniformity, and eyebox size of the corresponding display are improved, while reducing the size of the waveguide, in some implementations. In some embodiments, the first exit pupil expander and the second exit pupil expander are aligned such that at least one dimension of each of the first and second exit pupil expanders is non-parallel with respect to a corresponding dimension of the outcoupler of the waveguide.

Although some embodiments of the present disclosure are described and illustrated with reference to a particular example near-eye display system in the form of a WHUD, it will be appreciated that the apparatuses and techniques of the present disclosure are not limited to this particular example, but instead may be implemented in any of a variety of display systems using the guidelines provided herein.

FIG. 1 illustrates an example display system 100 employing a scanning-based optical system in accordance with some embodiments. The display system 100 has a support structure 102 that includes an arm 104, which houses a projector (e.g., a laser projector, a micro-LED projector, a Liquid Crystal on Silicon (LCOS) projector, or the like). The projector is configured to project images toward the eye of a user via a waveguide, such that the user perceives the projected images as being displayed in a field of view (FOV) area 106 of a display at one or both of lens elements 108, 110. In the depicted embodiment, the display system 100 is a near-eye display system in the form of a WHUD in which the support structure 102 is configured to be worn on the head of a user and has a general shape and appearance (that is, form factor) of an eyeglasses (e.g., sunglasses) frame.

The support structure 102 contains or otherwise includes various components to facilitate the projection of such images toward the eye of the user, such as a projector and a waveguide. In some embodiments, the support structure 102 further includes various sensors, such as one or more front-facing cameras, rear-facing cameras, other light sensors, motion sensors, accelerometers, and the like. In some embodiments, the support structure 102 includes one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1. It should be understood that instances of the term “or” herein refer to the non-exclusive definition of “or”, unless noted otherwise. For example, herein the phrase “X or Y” means “either X, or Y, or both”.

One or both of the lens elements 108, 110 are used by the display system 100 to provide an augmented reality (AR) display in which rendered graphical content can be superimposed over or otherwise provided in conjunction with a real-world view as perceived by the user through the lens elements 108, 110. For example, a projection system of the display system 100 uses light to form a perceptible image or series of images by projecting the display light onto the eye of the user via a projector of the projection system, a waveguide formed at least partially in the corresponding lens element 108 or 110, and one or more optical elements (e.g., one or more scan mirrors, one or more optical relays, or one or more collimation lenses that are disposed between the projector and the waveguide or integrated with the waveguide), according to various embodiments.

One or both of the lens elements 108, 110 includes at least a portion of a waveguide that routes display light received by an incoupler of the waveguide to an outcoupler of the waveguide, which outputs the display light toward an eye of a user of the display system 100. The display light is modulated and projected onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

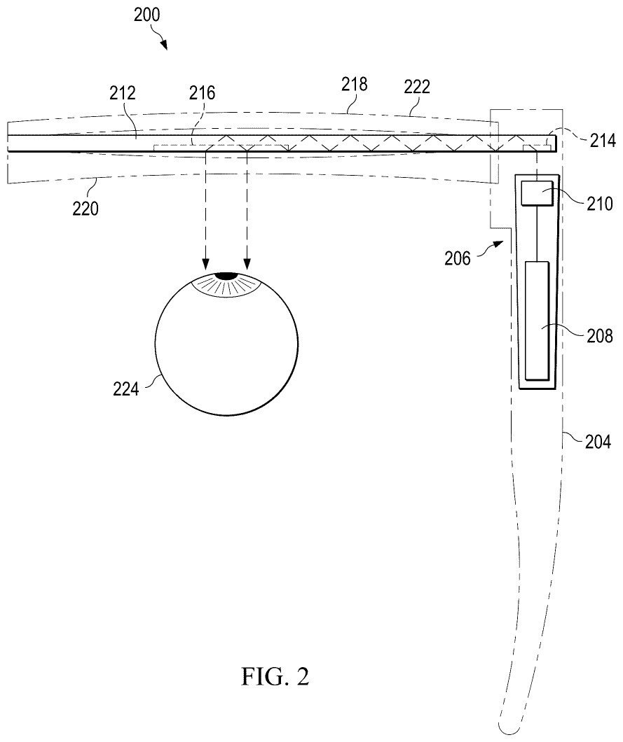

In some embodiments, the projector of the projection system of the display 100 is a digital light processing-based projector, a scanning laser projector, or any combination of a modulative light source, such as a laser or one or more light-emitting diodes (LEDs), and a dynamic reflector mechanism such as one or more dynamic scanners, reflective panels, or digital light processors (DLPs). In some embodiments, the projector includes a micro-display panel, such as a micro-LED display panel (e.g., a micro-AMOLED display panel, or a micro inorganic LED (i-LED) display panel) or a micro-Liquid Crystal Display (LCD) display panel (e.g., a Low Temperature PolySilicon (LTPS) LCD display panel, a High Temperature PolySilicon (HTPS) LCD display panel, or an In-Plane Switching (IPS) LCD display panel). In some embodiments, the projector includes a Liquid Crystal on Silicon (LCOS) display panel. Herein, such display panels are considered to be part of the optical engine (e.g., the optical engine 208 of FIG. 2) of the corresponding projection system. In some embodiments, a display panel of the projector is configured to output light (representing an image or portion of an image for display) into the waveguide of the projector. The waveguide expands the display light and outputs the display light toward the eye of the user via an outcoupler.

The projector is communicatively coupled to the controller and a non-transitory processor-readable storage medium or memory storing processor-executable instructions and other data that, when executed by the controller, cause the controller to control the operation of the projector. In some embodiments, the controller controls the projector to selectively set the location and size of the FOV area 106. In some embodiments, the controller is communicatively coupled to one or more processors (not shown) that generate content to be displayed at the display system 100. The projector outputs display light toward the FOV area 106 of the display system 100 via the waveguide. In some embodiments, at least a portion of an outcoupler of the waveguide overlaps the FOV area 106. Herein, the range of different user eye positions that will be able to see the display is referred to as the eyebox of the display.

FIG. 2 illustrates a portion of a display system 200 that includes a projection system having a projector 206 and a waveguide 212 with multiple optical paths between an incoupler 214 and an outcoupler 216 of the waveguide 212. In some embodiments, the display system 200 represents the display system 100 of FIG. 1. In the present example, the arm 204 of the display system 200 houses the projector 206, which includes an optical engine 208 (e.g., a display panel), one or more optical elements 210, the incoupler 214, and a portion of the waveguide 212.

The display system 200 includes an optical combiner lens 218, which includes a first lens 220, a second lens 222, and the waveguide 212, with the waveguide 212 embedded or otherwise disposed between the first lens 220 and the second lens 222. Light exiting through the outcoupler 216 travels through the first lens 220 (which corresponds to, for example, an embodiment of the lens element 110 of the display system 100). In use, the display light exiting the first lens 220 enters the pupil of an eye 224 of a user wearing the display system 200, causing the user to perceive a displayed image carried by the display light output by the optical engine 208. The optical combiner lens 218 is substantially transparent, such that light from real-world scenes corresponding to the environment around the display system 200 passes through the first lens 220, the second lens 222, and the waveguide 212 to the eye 224 of the user. In this way, images or other graphical content output by the projector 206 are combined (e.g., overlayed) with real-world images of the user's environment when projected onto the eye 224 of the user to provide an AR experience to the user.

The waveguide 212 of the display system 200 includes the incoupler 214 and the outcoupler 216. In some embodiments, one or more exit pupil expanders, such as a diffraction grating, is arranged in an intermediate stage between incoupler 214 and outcoupler 216 to receive light that is coupled into the waveguide 212 by the incoupler 214, expand the display light received at each exit pupil expander, and redirect that light towards the outcoupler 216, where the outcoupler 216 then couples the display light out of the waveguide 212 (e.g., toward the eye 224 of the user). In some embodiments, the waveguide 212 is configured to have a peak frequency response at a wavelength of green light, such as around 575 nm, which improves perceptibility of projected images output by the waveguide 212.

The term “waveguide,” as used herein, will be understood to mean a combiner using one or more of total internal reflection (TIR), specialized filters, or reflective surfaces, to transfer light from an incoupler (such as the incoupler 214) to an outcoupler (such as the outcoupler 216). In some display applications, the display light is a collimated image, and the waveguide transfers and replicates the collimated image to the eye. In general, the terms “incoupler” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the display light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the display light during the reflection. In the present example, the incoupler 214 relays received display light to the outcoupler 216 via multiple optical paths through the waveguide. In some embodiments, the incoupler 214 redirects a first portion of display light to the outcoupler 216 via a first optical path along which a first exit pupil expander (not shown; implemented as a fold grating in some embodiments) is disposed and redirects a second portion of display light toward the outcoupler 216 via a second optical path along which a second exit pupil expander (not shown; implemented as a fold grating in some embodiments) is disposed. The display light propagates through the waveguide 212 via TIR. The outcoupler 216 then outputs the display light to the eye 224 of the user.

In some embodiments, the projector 206 is coupled to a driver or other controller (not shown), which controls the timing of emission of display light from light sources (e.g., LEDs) of the optical engine 208 in accordance with instructions received by the controller or driver from a computer processor (not shown) coupled thereto to modulate the output light to be perceived as images when output to the retina of the eye 224 of the user. For example, during operation of the display system 200, by the light sources of the optical engine 208 output light of selected wavelengths, and the output light is directed to the eye 224 of the user via the optical elements 210 and the waveguide 212. The optical engine 208 modulates the respective intensities of each light source of the optical engine 208, such that the output light represents pixels of an image. For example, the intensity of a given light source or group of light sources of the optical engine 208 corresponds to the brightness of a corresponding pixel of the image to be projected by the projector 206 of the display system 200.

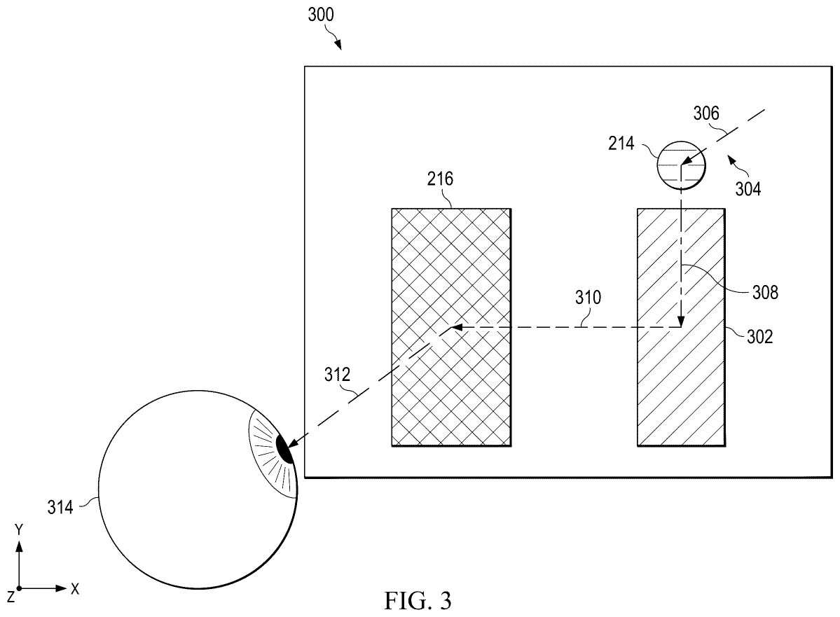

FIG. 3 shows a partially transparent perspective view (a “front” view) of a waveguide 300 (e.g., an embodiment of the waveguide 212 of the display system 200 of FIG. 2) in accordance with some embodiments. A light source, such as an embodiment of the optical engine 208 of FIG. 2, outputs display light 304 into the waveguide 300 along a first trajectory 306. As shown, the incoupler 214 redirects the display light 304 toward an exit pupil expander 302 along a second trajectory 308. In the present example, the second trajectory 308 extends in the negative y dimension. It should be noted that trajectories described herein are sometimes described with respect to the illustrated cartesian coordinate system (e.g., with respect to the x-, y-, and z-axes shown). The exit pupil expander 302 redirects the display light 304 to the outcoupler 216 along a third trajectory 310. In the present example, the third trajectory 310 extends in the negative x dimension. The outcoupler redirects the display light 304, such that the display light 304 is output toward the eye 314 of the user along a fourth trajectory 312. In some embodiments, the first trajectory 306 and the fourth trajectory 312 are parallel or substantially (e.g., within around 5%) parallel with respect to one another.

In some embodiments, the exit pupil expander 302 is an optical grating, such as a diffraction grating or holographic grating, that is configured to redirect the display light 304 along the third trajectory 310 and that expands one or more dimensions of the eyebox of a display system (e.g., the display system 100 of FIG. 1; the display system 200 of FIG. 2) that includes the waveguide 300 (e.g., with respect to what the dimensions of the eyebox of the display would be without the exit pupil expander 302).

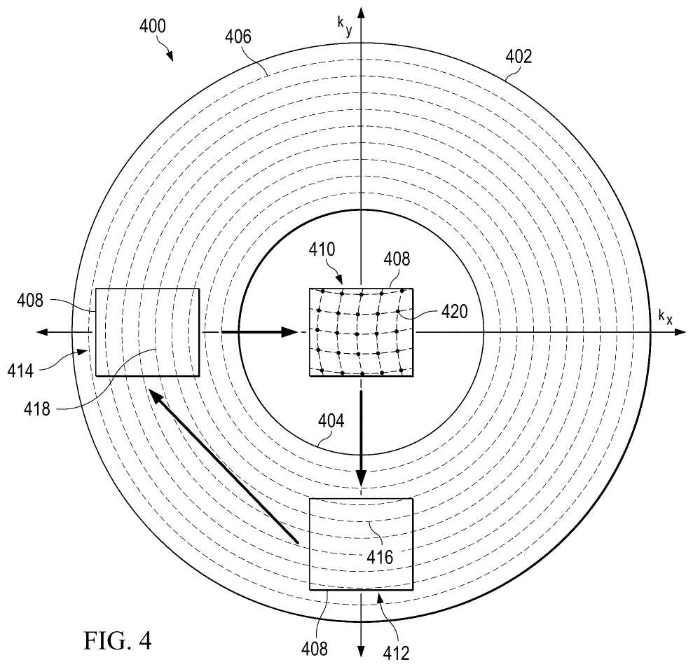

FIG. 4 illustrates a normalized k-space chart 400 representing propagation of display light through the waveguide 300 of FIG. 3 with respect to k-space. That is, the chart 400 is a k-space chart corresponding to a two-dimensional (2D) generalization of the waveguide 300. Accordingly, some aspects of the present example are described with respect to the waveguide 300 of FIG. 3 and elements thereof.

For light of a given wavelength λ in a material with a bulk refractive index of n, the propagation vector for light traveling through the waveguide 300 will have a total magnitude k=(2πn)/λ. The variable k is sometimes referred to as the wavenumber and as used herein is defined as the reciprocal of wavelength, such that k=1/λ. A given propagation angle in 2D k-space is represented as a circle, requiring k²=kₓ²+k_{y}². Only light traveling at propagation angles between a first boundary angle 402 and a second boundary angle 404 is able to propagate along the waveguide 300 via TIR. Further, only light traveling at discrete propagation angles (i.e., discrete polar angles), represented by lines 406 (dashed circles located between the first boundary angle 402 and the second boundary angle 404) is able to propagate along the waveguide 300 via TIR.

Initially, the display light 304 entering the waveguide 300 at the incoupler 214 is centered at or around the origin of the chart 400. Here, an image 408 represents an image carried by the display light 304. The image 408 is initially disposed at a first position 410 with respect to k-space. Upon redirection of the display light 304 by the incoupler 214, the image 408 is shifted in k-space to a second position 412, corresponding to a shift in the negative k_{y} dimension. Upon redirection of the display light 304 by the exit pupil expander 302, the image 408 is shifted in k-space to a third position 414, corresponding to a shift in the positive k_{y} dimension and the negative kₓ dimension. Upon redirection of the display light 304 by the outcoupler 216, the image 408 is shifted in k-space back to the first position 410, corresponding to a shift in the positive kₓ dimension. In the present example, it is assumed that the angle at which the display light 304 enters the waveguide 300 via the incoupler 214 is the same as or substantially the same as (e.g., within 5% of) the angle at which the display light 304 exits the waveguide 300 via the outcoupler 216. In a waveguide, such as the waveguide 300, only portions of light traveling at certain propagation angles (e.g., corresponding to the lines 406 in the present example) are able to successfully propagate through the waveguide, resulting in image information conveyed by portions of the display light that do not travel at those propagation angles being at least partially lost. This process is sometimes referred to as discretization. For example, at the second position 412, only the portions of display light that convey portions of the image 408 overlapped by lines 416 (corresponding to portions of a subset of the lines 406) are able to successfully propagate through the waveguide 300 via TIR. At the third position 414, only portions of display light that convey portions of the image 408 overlapped by lines 418 (corresponding to portions of a subset of the lines 406) are able to successfully propagate along the waveguide 300. Thus, once the image 408 returns to the position 410 upon being redirected out of the waveguide 300, only portions of the image 408 corresponding to discrete intersections 420 of the lines 416 and the lines 418 (the points at which the lines 416 and 418 would intersect if overlapped as shown) are preserved. Herein, portions of an image that are preserved due to successful propagation of corresponding light through the waveguide 212 are considered to undergo less significant loss of image information from discretization. The portions of display light that convey portions of the image 408 and that do not correspond to the discrete intersections 420 are not fully propagated through the waveguide 300 and corresponding image information is at least partially lost (e.g., undergoing more significant loss of image information from discretization than the portions of the image corresponding to the discrete intersections 420). The spatial or angular resolution of the image 408 carried by the display light 304 that exits the waveguide 300 corresponds, at least in part, to the quantity and density of the discrete intersections 420. Each of the intersections 420 corresponds to a respective portion of the image 408 and a respective set of viewing angles. The spatial or angular resolution of the output image 408 corresponds to how much of the image 408 is retained after the corresponding display light 304 propagates through the waveguide 300.

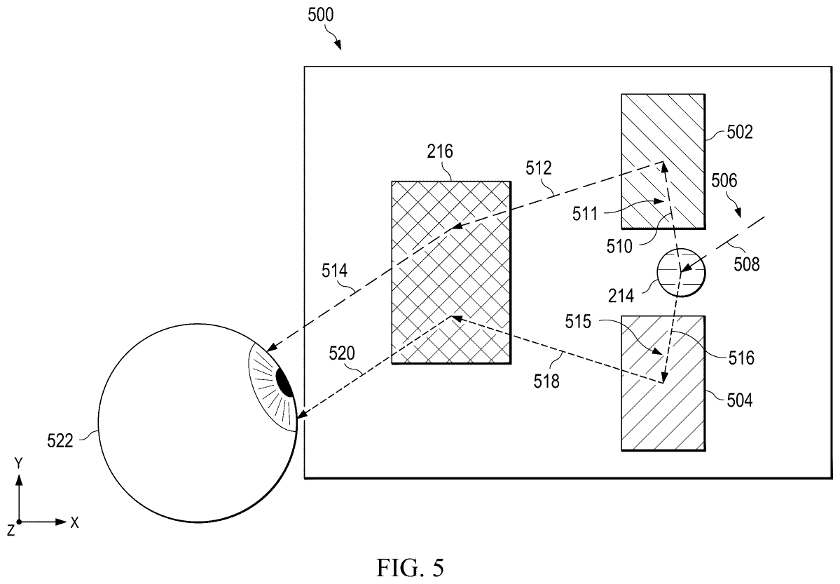

FIG. 5 shows a partially transparent perspective view (a “front” view) of a waveguide 500 (e.g., an embodiment of the waveguide 212 of the display system 200 of FIG. 2) in accordance with some embodiments. The waveguide 500 includes an incoupler 214, a first exit pupil expander 502, a second exit pupil expander 504, and an outcoupler 216. In some embodiments, each of the first exit pupil expander 502 and the second exit pupil expander 504 include an optical grating, such as a diffraction grating or holographic grating, that is configured to redirect and expand received display light, thereby expanding one or more dimensions of the eyebox of a display system (e.g., the display system 100 of FIG. 1; the display system 200 of FIG. 2) that includes the waveguide 500.

During operation, a light source, such as an embodiment of the optical engine 208 of FIG. 2, outputs display light 506 into the waveguide 500 along a first trajectory 508. The incoupler 214 divides the display light 506 into a first portion 511 (sometimes referred to as a “first portion of display light 511”) and a second portion 515 (sometimes referred to herein as a “second portion of display light 515). In some embodiments, the display light 506 conveys an image, referred to herein as the “original” image, the first portion of display light 511 conveys a first image, the second portion of display light 515 conveys a second image, and the combined first and second portions of display light 511 and 515 output via the outcoupler 216 convey a “final” image that is a combination of the first image and the second image. In some embodiments, each of the first image and the second image correspond to the original image, but with respectively different portions of the original image having not been preserved (i.e., having undergone significantly higher loss of image information than preserved portions of the original image) in each of the first image and the second image due to discretization as the first portion of display light 511 and the second portion of display light 515 travel through the waveguide 500 along respectively different optical paths.

The incoupler 214 redirects the first portion of display light 511 toward a first exit pupil expander 502 along a second trajectory 510. In the present example, the second trajectory 510 extends in the positive y dimension and the negative x dimension. The first exit pupil expander 502 redirects the first portion of display light 511 to the outcoupler 216 along a third trajectory 512. In the present example, the third trajectory 512 extends in the negative x dimension and the negative y dimension. The outcoupler redirects the first portion of display light 511 out of the waveguide 500, such that the first portion of display light 511 is output toward the eye 522 of the user along a fourth trajectory 514. The incoupler 214 redirects the second portion of display light 515 toward a second exit pupil expander 504 via a fifth trajectory 516. In the present example, the fifth trajectory 516 extends in the negative y dimension and the negative x dimension. The second exit pupil expander 504 redirects the second portion of display light 515 toward the outcoupler 216 via a sixth trajectory 518. In the present example, the sixth trajectory 518 extends in the positive y dimension and the negative x dimension. The outcoupler 216 redirects the second portion of display light 515 out of the waveguide 500 and toward the eye 522 of the user via a seventh trajectory 520. The first trajectory 508, the fourth trajectory 514, and the seventh trajectory 520 are parallel or substantially (e.g., within around 5%) parallel with respect to one another, in some embodiments.

In the present example, the second trajectory 510, the third trajectory 512, and the fourth trajectory 514 are considered to be a first optical path through the waveguide 500, and the fifth trajectory 516, the sixth trajectory 518, and the seventh trajectory 520 are considered to be a second optical path through the waveguide 500, where the first optical path is different from the second optical path. For example, at least some of the propagation angles of the first portion of display light 511 as it travels along the trajectories of the first optical path are different from otherwise corresponding propagation angles of the second portion of display light 515 as it travels along trajectories of the second optical path. Each time the trajectory of light (e.g., the display light 506, the first portion of display light 511, the second portion of display light 515) within the waveguide 500 changes (e.g., due to incidence on a diffraction grating, such as the incoupler 214, the first exit pupil expander 502, the second exit pupil expander 504, or the outcoupler 216), a portion of the image conveyed by that light undergoes a more significant loss of image information and the remainder of the image is preserved (i.e., undergoes a less significant loss of image information). For example, the portion of the image that is preserved corresponds to the portion of the display light that propagates at propagation angles for which TIR is achievable through the waveguide 500, while the portion of the image for which image information undergoes comparatively significant loss corresponds to the portion of display light that propagates at any other propagation angle. Because the first portion of display light 511 travels along the first optical path with different propagation angles than those of the second portion of display light 515 when traveling along the second optical path, the preserved portions of the original image carried by the first portion of display light 511 are different from the preserved portions of the original image carried by the second portion of display light 515. Thus, the final image output via the outcoupler 216 has a higher spatial or angular resolution than either the first image or the second image alone.

In some embodiments, the first portion of display light 511 that conveys the first image utilizes a first set of optical modes and the second portion of display light 515 that conveys the second image utilizes a second set of optical modes, and the first portion of display light 511 and the second portion of display light 515 traverse spatially distinct paths. That is, the first set of optical modes and the second set of optical modes are respectively non-overlapping or partially non-overlapping, with each of the first and second sets of optical modes corresponding to respectively different portions of the original image. In this way, the density of optical modes of utilized to convey the final image are increased, compared that of the optical modes utilized to convey the first image alone or those utilized to convey the second image alone (e.g., compared to a waveguide that only includes one of the first or second optical paths). By redirecting the display light 506 through the waveguide 500 via multiple optical paths, the spatial or angular resolution of images conveyed via the waveguide 500 is advantageously increased.

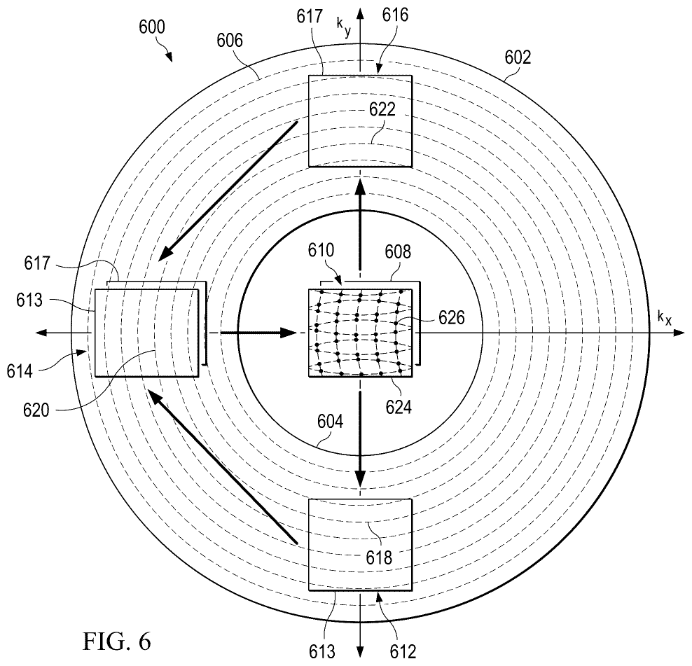

FIG. 6 shows a chart 600 representing propagation of display light through the waveguide 500 of FIG. 5 with respect to k-space. That is, the chart 600 is a k-space chart corresponding to a two-dimensional (2D) generalization of the waveguide 500. Accordingly, some aspects of the present example are described with respect to the waveguide 500 and elements thereof.

For light of a given wavelength A in a material with a bulk refractive index of n, the propagation vector for light traveling through the waveguide 500 will have a total magnitude k=(2πn)/λ. A given propagation angle in 2D k-space is represented as a circle, requiring k²=kₓ²+k_{y}². Only light traveling at propagation angles between a first boundary angle 602 and a second boundary angle 604 is able to propagate along the waveguide 500 via TIR. Further, only light traveling at discrete propagation angles (i.e., discrete polar angles), represented by lines 606 (dashed circles located between the first boundary angle 602 and the second boundary angle 604) is able to successfully propagate along the waveguide 500 via TIR. The lines 606 are sometimes referred to herein as “propagation angles 606”.

Initially, the display light 506 entering the waveguide 500 at the incoupler 214 is centered at or around the origin of the chart 600. Here, an original image 608 represents an image carried by the display light 506. The original image 608 is initially disposed at a first position 610 with respect to k-space when entering the waveguide 500 along the first trajectory 508. Upon redirection of the display light 506 by the incoupler 214, the original image 608 is divided into a first image 617, conveyed by the first portion of display light 511, and a second image 613, conveyed by the second portion of display light 515. Upon redirection of the first portion of display light 511 by the incoupler 214, the first image 617 is shifted in k-space to a second position 616, corresponding to a shift in the positive k_{y} dimension. Upon redirection of the second portion of display light 515 by the incoupler 214, the second image 613 is shifted in k-space to a third position 612, corresponding to a shift in the negative k_{y} dimension. Upon redirection of the first portion of display light 511 by the first exit pupil expander 502, the first image 617 is shifted in k-space to a fourth position 614, corresponding to a shift in the negative k_{y} dimension and the negative kₓ dimension. Upon redirection of the second portion of display light 515 by the second exit pupil expander 504, the second image 613 is shifted in k-space to the fourth position 614, corresponding to a shift in the positive k_{y} dimension and the negative kₓ dimension. Upon redirection of the first portion of display light 511 and the second portion of display light 515 by the outcoupler 216, the first image 617 and the second image 613 are combined to form a final image 624, and the final image 624 is shifted in k-space back to the first position 610, corresponding to a shift in the positive kₓ dimension.

In some embodiments, the first image 617 and the second image 613 are each a representation of the original image 608. In some embodiments, the first image 617 corresponds to a first spatial portion of the original image 608, and the second image 613 corresponds to a second spatial portion of the original image 608. In certain embodiments, the first and second spatial portions of the original image 608 partially overlap. In some embodiments, the first image 617 corresponds to a first representation of the original image 608 that includes only a first set of wavelengths of light (i.e., colors) of the original image 608, the second image 613 corresponds to a second representation of the original image 608 that includes only a second set of wavelengths of light (i.e., colors) of the original image 608, and the first set of wavelengths of light is different from the second set of wavelengths of light.

In the present example, it is assumed that the angle at which the display light 506 enters the waveguide 500 via the incoupler 214 is the same as or substantially the same as (e.g., within 5% of) the angle at which the first and second portions of display light 511 and 515 exit the waveguide 500 via the outcoupler 216. At the second position 616, only light that conveys the portions of the first image 617 overlapped by lines 622 (corresponding to portions of a subset of the lines 606) is able to propagate along the waveguide 500 via TIR. At the third position 612, only the portions of the second image 613 overlapped by lines 618 (corresponding to portions of a subset of the lines 606) are able to propagate along the waveguide 500 via TIR. At the fourth position 614, only the portions of the first image 617 and the second image 613 overlapped by lines 620 (corresponding to portions of a subset of the lines 606) are able to propagate along the waveguide 500. Thus, the final image 624 returns to the first position 610 (due to shifting and combining of the first image 617 and the second image 613 at the outcoupler 216) upon being redirected out of the waveguide 500.

Only portions of the original image 608 corresponding to discrete intersections 626 are preserved in the final image 624. For example, the intersections 626 include portions of the first image 617 that are overlapped by intersections of the lines 622 and the lines 620 and portions of the second image 613 that are overlapped by intersections of the lines 618 and the lines 620 (these intersections corresponding to the points at which the corresponding lines would intersect if overlapped as shown). At least a portion of the image information corresponding to the portions of the original image 608 that are not located at the intersections 626 undergo more significant loss of image information than those portions that are located at the intersections 626, as the corresponding light does not successfully propagate through the waveguide 500 via TIR. In some embodiments, the spatial or angular resolution of the final image 624 corresponds to the quantity and density of the discrete intersections 626. That is, the spatial or angular resolution of the final image 624 corresponds to how much of the original image 608 is retained after the corresponding light propagates through the waveguide 500.

A first set of intersections of the intersections 626 corresponds to intersections of the lines 622 and the lines 620 from the first image 617 and a second set of intersections of the intersections 626 corresponds to the intersections of the lines 618 and the lines 620 from the second image 613. As shown, the first set of intersections is spatially separated from the second set of intersections, such that the final image 624 includes a greater quantity of intersections 626 than is included in either the first image 617 or the second image 613 individually. Thus, by dividing the display light 506 into first and second portions 511 and 515 and propagating the first and second portions 511 and 515 through the waveguide 500 via two different optical paths with different propagation angles, the spatial or angular resolution of the final image 624 is advantageously increased, such that the spatial or angular resolution of the final image 624 is increased (e.g., relative to the output image 408 of FIG. 4).

It should be noted that the number of propagation angles 606 that allow light to successfully propagate through the waveguide 500 via TIR is typically greater than that shown in the present example and, accordingly, the number of discrete intersections 626 in the final image 624 would be greater than that shown in such instances. That is, reduced quantities of propagation angles 606 and intersections 626 are shown in the present example for ease of illustration.

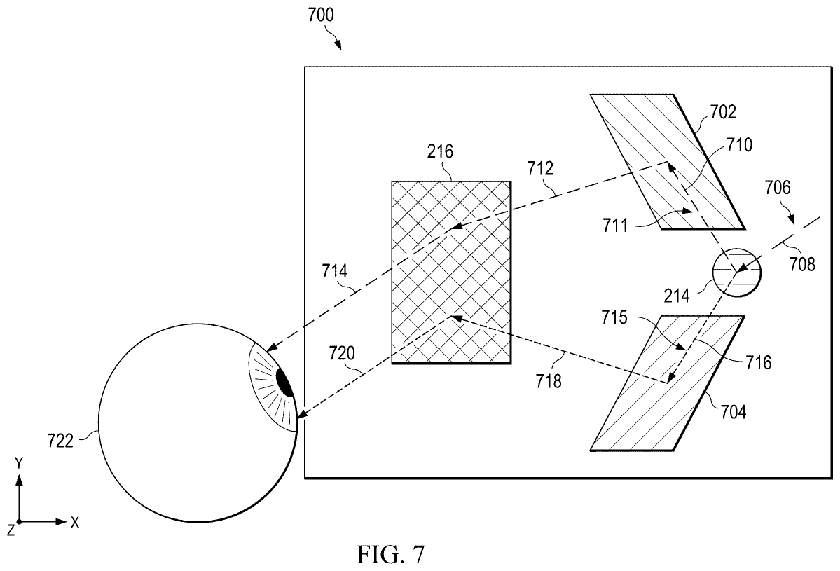

FIG. 7 shows a partially transparent perspective view (a “front” view) of a waveguide 700 (e.g., an embodiment of the waveguide 212 of the display system 200 of FIG. 2) in accordance with some embodiments. The waveguide 700 includes an incoupler 214, a first exit pupil expander 702, a second exit pupil expander 704, and an outcoupler 216. In some embodiments, each of the first exit pupil expander 702 and the second exit pupil expander 704 include an optical grating, such as a diffraction grating or holographic grating, that is configured to redirect and expand received display light, thereby expanding one or more dimensions of the eyebox of a display system (e.g., the display system 100 of FIG. 1; the display system 200 of FIG. 2) that includes the waveguide 700. As shown, the first exit pupil expander 702 is disposed having a primary dimension that extends away from the incoupler 214 in both the negative x dimension and the positive y dimension, and the second exit pupil expander 704 is disposed having a primary dimension that extends away from the incoupler 214 in both the negative x dimension and the negative y dimension. In some embodiments, the magnitude to which the first and second exit pupil expanders 702 and 704 extend in the x dimension (either the positive or negative x dimension, according to various embodiments) is different from that shown, such that the amount by which each of the first and second exit pupil expanders 702 and 704 are angled toward or away from the outcoupler 216 is different from that shown. The dimensions of the first exit pupil expander 702 and the second exit pupil expander 704 cause incident light to be shifted in both the kₓ and k_{y} dimensions in k-space.

During operation, a light source, such as an embodiment of the optical engine 208 of FIG. 2, outputs display light 706 into the waveguide 700 along a first trajectory 708. The incoupler 214 divides the display light 706 into a first portion 711 (sometimes referred to as a “first portion of display light 711”) and a second portion 715 (sometimes referred to herein as a “second portion of display light 715). In some embodiments, the incoupler 214 includes a two-dimensional grating. In some embodiments, the incoupler 214 includes two one-dimensional gratings. In some embodiments, the display light 706 conveys an image, referred to herein as the “original” image, the first portion of display light 711 conveys a first image, the second portion of display light 715 conveys a second image, and the combined first and second portions of display light 711 and 715 output via the outcoupler 216 convey a “final” image that is a combination of the first image and the second image.

In some embodiments, each of the first image and the second image correspond to the original image, but with respectively different portions of the original image having undergone more significant loss of image information in each of the first image and the second image due to discretization as the first portion of display light 711 and the second portion of display light 715 travel through the waveguide 700 along respectively different optical paths. The incoupler 214 redirects the first portion of display light 711 toward a first exit pupil expander 702 along a second trajectory 710. In the present example, the second trajectory 710 extends in the positive y dimension and the negative x dimension. The first exit pupil expander 702 redirects the first portion of display light 711 to the outcoupler 216 along a third trajectory 712. In the present example, the third trajectory 712 extends in the negative x dimension and the negative y dimension. The outcoupler redirects the first portion of display light 711 out of the waveguide 700, such that the first portion of display light 711 is output toward the eye 722 of the user along a fourth trajectory 714. The incoupler 214 redirects the second portion of display light 715 toward a second exit pupil expander 704 via a fifth trajectory 716. In the present example, the fifth trajectory 716 extends in the negative y dimension and the negative x dimension. The second exit pupil expander 704 redirects the second portion of display light 715 toward the outcoupler 216 via a sixth trajectory 718. In the present example, the sixth trajectory 718 extends in the positive y dimension and the negative x dimension. The outcoupler 216 redirects the second portion of display light 715 out of the waveguide 700 and toward the eye 722 of the user via a seventh trajectory 720. The first trajectory 708, the fourth trajectory 714, and the seventh trajectory 720 are parallel or substantially (e.g., within around 7%) parallel with respect to one another, in some embodiments.

In the present example, the second trajectory 710, the third trajectory 712, and the fourth trajectory 714 are considered to be a first optical path through the waveguide 700, and the fifth trajectory 716, the sixth trajectory 718, and the seventh trajectory 720 are considered to be a second optical path through the waveguide 700, where the first optical path is different from the second optical path. For example, at least some of the propagation angles of the first portion of display light 711 as it travels along the trajectories of the first optical path are different from otherwise corresponding propagation angles of the second portion of display light 715 as it travels along trajectories of the second optical path.

Each time the trajectory of display light (e.g., the display light 706, the first portion of display light 711, the second portion of display light 715) within the waveguide 700 changes (e.g., due to incidence on a diffraction grating, such as the incoupler 214, the first exit pupil expander 702, the second exit pupil expander 704, or the outcoupler 216), image information for a portion of the image conveyed by that light undergoes more significant loss and the remainder of the image is undergoes less significant loss. For example, the portion of the original image that is preserved (i.e., the portion having image information that undergoes less significant loss) corresponds to the portion of the display light that propagates at propagation angles for which TIR is achievable through the waveguide 700, while the portion of the image that is not preserved (i.e., the portion having image information that undergoes more significant loss) corresponds to the portion of display light that propagates at any other propagation angle. The first image conveyed by the first portion of display light 711 and the second image conveyed by the second portion of display light 715 each correspond to at least a portion of the original image. Because the first portion of display light 711 travels along the first optical path with different propagation angles than those of the second portion of display light 715 when traveling along the second optical path along, the preserved portions of the original image carried by the first portion of display light 711 are different from the preserved portions of the original image carried by the second portion of display light 715.

In some embodiments, the first portion of display light 711 that conveys the first image utilizes a first set of optical modes and the second portion of display light 715 that conveys the second image utilizes a second set of optical modes, and the first portion of display light 711 and the second portion of display light 715 traverse spatially distinct paths. That is, the first set of optical modes and the second set of optical modes are respectively non-overlapping or partially non-overlapping, with each of the first and second sets of optical modes corresponding to respectively different portions of the original image. In this way, the density of optical modes of utilized to convey the final image are increased, compared that of the optical modes utilized to convey the first image alone or those utilized to convey the second image alone (e.g., compared to a waveguide that only includes one of the first or second optical paths).

Thus, the final image output via the outcoupler 216 has a higher spatial or angular resolution than either the first image or the second image alone. By redirecting the display light 706 through the waveguide 700 via multiple optical paths, therefore, the spatial or angular resolution of images conveyed via the waveguide 700 is advantageously increased. Further, because the first and second exit pupil expanders 702 and 704 are not require to extend away from the incoupler 214 in only the positive and negative y dimensions in the present example, the alignments of the first and second exit pupil expanders 702 and 704 effectively become free variables, which can be tuned to improve the efficiency, uniformity, and eyebox size of the display and to reduce the size of the waveguide 700.

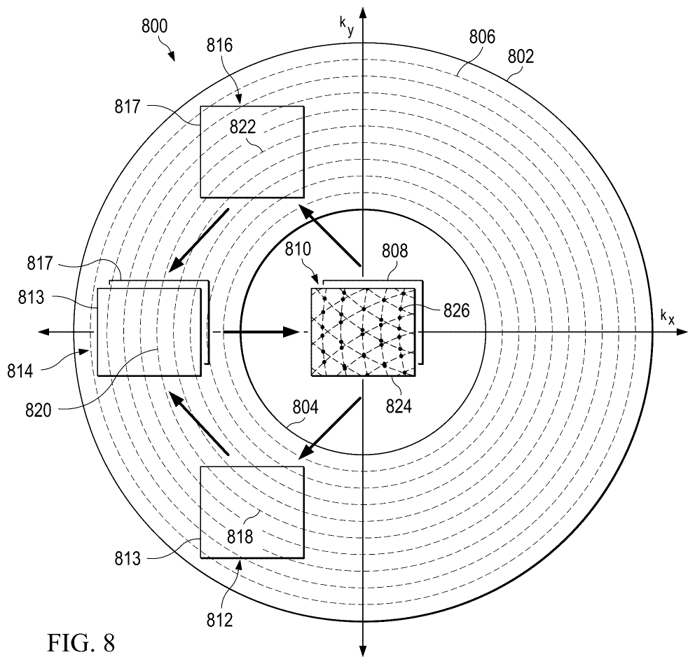

FIG. 8 shows a chart 800 representing propagation of display light through the waveguide 700 of FIG. 7 with respect to k-space. That is, the chart 800 is a k-space chart corresponding to a two-dimensional (2D) generalization of the waveguide 700. Accordingly, some aspects of the present example are described with respect to the waveguide 700 and elements thereof.

For light of a given wavelength A in a material with a bulk refractive index of n, the propagation vector for light traveling through the waveguide 700 will have a total magnitude k=(2πn)/λ. A given propagation angle in 2D k-space is represented as a circle, requiring k²=kₓ²+k_{y}². Only light traveling at propagation angles between a first boundary angle 802 and a second boundary angle 804 is able to propagate along the waveguide 700 via TIR. Further, only light traveling at discrete propagation angles (i.e., discrete polar angles), represented by lines 806 (dashed circles located between the first boundary angle 802 and the second boundary angle 804) is able to propagate along the waveguide 700 via TIR. The lines 806 are sometimes referred to herein as “propagation angles 806”.

Initially, the display light 706 entering the waveguide 700 at the incoupler 214 is centered at or around the origin of the chart 800. Here, an original image 808 represents an image carried by the display light 706. The original image 808 is initially disposed at a first position 810 with respect to k-space when entering the waveguide 700 along the first trajectory 708. Upon redirection of the display light 706 by the incoupler 214, the original image is divided into a first image 817, conveyed by the first portion of display light 711, and a second image 813, conveyed by the second portion of display light 715. Upon redirection of the first portion of display light 711 by the incoupler 214, the first image 817 is shifted in k-space to a second position 816, corresponding to a shift in the positive k_{y} dimension and the negative kₓ dimension. Upon redirection of the second portion of display light 715 by the incoupler 214, the second image 813 is shifted in k-space to a third position 812, corresponding to a shift in the negative k_{y} dimension and the negative kₓ dimension. Upon redirection of the first portion of display light 711 by the first exit pupil expander 702, the first image 817 is shifted in k-space to a fourth position 814, corresponding to a shift in the negative k_{y} dimension and the negative kₓ dimension. Upon redirection of the second portion of display light 715 by the second exit pupil expander 704, the second image 813 is shifted in k-space to the fourth position 814, corresponding to a shift in the positive k_{y} dimension and the negative kₓ dimension. Upon redirection of the first portion of display light 711 and the second portion of display light 715 by the outcoupler 216, the first image 817 and the second image 813 are combined to form a final image 824, and the final image 824 is shifted in k-space back to the first position 810, corresponding to a shift in the positive kₓ dimension. By shifting the first and second images 817 and 813 in both the kₓ and k_{y} dimensions (rather than only the k_{y} dimension) upon redirection of the first and second portions of display light 711 and 715 by the incoupler 214, the efficiency, uniformity, and eyebox size of the corresponding display are improved, while reducing the size of the waveguide 700, in some embodiments.

In some embodiments, the first image 817 and the second image 813 are each a representation of the original image 808. In some embodiments, the first image 817 corresponds to a first spatial portion of the original image 808, and the second image 813 corresponds to a second spatial portion of the original image 808. In certain embodiments, the first and second spatial portions of the original image 608 partially overlap. In some embodiments, the first image 817 corresponds to a first representation of the original image 808 that includes only a first set of wavelengths of light (i.e., colors) of the original image 808, the second image 813 corresponds to a second representation of the original image 808 that includes only a second set of wavelengths of light (i.e., colors) of the original image 808, and the first set of wavelengths of light is different from the second set of wavelengths of light.

In the present example, it is assumed that the angle at which the display light 706 enters the waveguide 700 via the incoupler 214 is the same as or substantially the same as (e.g., within 5% of) the angle at which the first and second portions of display light 711 and 715 exit the waveguide 700 via the outcoupler 216. At the second position 816, only light that conveys the portions of the first image 817 overlapped by lines 822 (corresponding to portions of a subset of the lines 806) is able to propagate along the waveguide 700 via TIR. At the third position 812, only light that conveys the portions of the second image 813 overlapped by lines 818 (corresponding to portions of a subset of the lines 806) is able to propagate along the waveguide 700 via TIR. At the fourth position 814, only light that conveys the portions of the first image 817 and the second image 813 overlapped by lines 820 (corresponding to portions of a subset of the lines 806) is able to propagate along the waveguide 700. Thus, the final image 824 returns to the first position 810 (due to shifting and combining of the first image 817 and the second image 813 at the outcoupler 216) upon being redirected out of the waveguide 700.

Only portions of the original image 808 corresponding to discrete intersections 826 are preserved in the final image 824. For example, the intersections 826 include portions of the first image 817 that are overlapped by intersections of the lines 822 and the lines 820 and portions of the second image 813 that are overlapped by intersections of the lines 818 and the lines 820 (these intersections corresponding to the points at which the corresponding lines would intersect if overlapped as shown). At least a portion of the image information corresponding to the portions of the original image 808 that are not located at the intersections 826 is lost, as the corresponding light does not successfully propagate through the waveguide 700 via TIR. In some embodiments, the spatial or angular resolution of the final image 824 corresponds to the quantity and density of the discrete intersections 826. That is, the spatial or angular resolution of the final image 824 corresponds to how much of the original image 808 is retained after the corresponding light propagates through the waveguide 700.

A first set of intersections of the intersections 826 corresponds to intersections of the lines 822 and the lines 820 from the first image 817 and a second set of intersections of the intersections 826 corresponds to the intersections of the lines 818 and the lines 820 from the second image 813. As shown, the first set of intersections is spatially separated from the second set of intersections, such that the final image 824 includes a greater quantity of intersections 826 than the quantity of such intersections included in either the first image 817 or the second image 813 individually. Thus, by dividing the display light 706 into first and second portions 711 and 715 and propagating the first and second portions 711 and 715 through the waveguide 700 via two different optical paths with different propagation angles, the spatial or angular resolution of the final image 824 is advantageously increased, such that the spatial or angular resolution of the final image 824 is increased (e.g., relative to the output image 408 of FIG. 4).

It should be noted that the number of propagation angles 806 that allow light to successfully propagate through the waveguide 700 via TIR is typically greater than that shown in the present example and, accordingly, the number of discrete intersections 826 in the final image 824 would be greater than that shown in such instances. That is, reduced quantities of propagation angles 806 and intersections 826 are shown in the present example for ease of illustration.

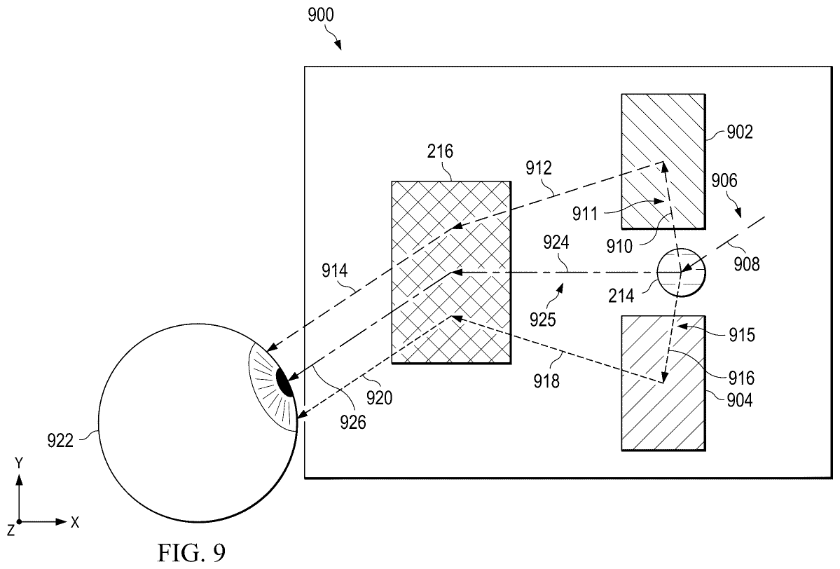

FIG. 9 shows a partially transparent perspective view (a “front” view) of a waveguide 900 (e.g., an embodiment of the waveguide 212 of the display system 200 of FIG. 2) in accordance with some embodiments. The waveguide 900 includes an incoupler 214, a first exit pupil expander 902, a second exit pupil expander 904, and an outcoupler 216. In some embodiments, each of the first exit pupil expander 902 and the second exit pupil expander 904 include an optical grating, such as a diffraction grating or holographic grating, that is configured to redirect and expand received display light, thereby expanding one or more dimensions of the eyebox of a display system (e.g., the display system 100 of FIG. 1; the display system 200 of FIG. 2) that includes the waveguide 900.

During operation, a light source, such as an embodiment of the optical engine 208 of FIG. 2, outputs display light 906 into the waveguide 900 along a first trajectory 908. The incoupler 214 divides the display light 906 into a first portion 911 (sometimes referred to as a “first portion of display light 911”), a second portion 915 (sometimes referred to herein as a “second portion of display light 915), and a third portion 925 (sometimes referred to herein as a “third portion of display light 925). In some embodiments, the display light 906 conveys an image, referred to herein as the “original” image, the first portion of display light 911 conveys a first image, the second portion of display light 915 conveys a second image, the third portion of display light 925 conveys a third image, and the combined first portion of display light 911, second portion of display light 915, and third portion of display light 925 output via the outcoupler 216 convey a “final” image that is a combination of the first image and the second image. In some embodiments, each of the first image, the second image, and the third image correspond to the original image, but with image information corresponding to respectively different portions of the original image having been at least partially lost in each of the first image, the second image, and the third image due to discretization as the first portion of display light 911, the second portion of display light 915, and the third portion of display light 925 travel through the waveguide 900 along respectively different optical paths. In some embodiments, the third image represents only a portion of the original image and results in an increase in the spatial or angular resolution of only a portion of the final image, since the geometry of the third image is not increased by an exit pupil expander in the same way as the geometries of the first and second images are increased by the first and second image pupil expanders 902 and 904.

The incoupler 214 redirects the first portion of display light 911 toward a first exit pupil expander 902 along a second trajectory 910. In the present example, the second trajectory 910 extends in the positive y dimension and the negative x dimension. The first exit pupil expander 902 redirects the first portion of display light 911 to the outcoupler 216 along a third trajectory 912. In the present example, the third trajectory 912 extends in the negative x dimension and the negative y dimension. The outcoupler redirects the first portion of display light 911 out of the waveguide 900, such that the first portion of display light 911 is output toward the eye 922 of the user along a fourth trajectory 914. The incoupler 214 redirects the second portion of display light 915 toward a second exit pupil expander 904 via a fifth trajectory 916. In the present example, the fifth trajectory 916 extends in the negative y dimension and the negative x dimension. The second exit pupil expander 904 redirects the second portion of display light 915 toward the outcoupler 216 via a sixth trajectory 918. In the present example, the sixth trajectory 918 extends in the positive y dimension and the negative x dimension. The outcoupler 216 redirects the second portion of display light 915 out of the waveguide 900 and toward the eye 922 of the user via a seventh trajectory 920. The incoupler 214 redirects the third portion of display light 925 toward the outcoupler 216 via an eighth trajectory 924. In the present example, the ninth trajectory 924 extends in the negative x dimension. The outcoupler 216 redirects the third portion of display light 926 out of the waveguide 900 and toward the eye 922 of the user via a ninth trajectory 926. The first trajectory 908, the fourth trajectory 914, the seventh trajectory 920, and the ninth trajectory 926 are parallel or substantially (e.g., within around 5%) parallel with respect to one another, in some embodiments.

In the present example, the second trajectory 910, the third trajectory 912, and the fourth trajectory 914 are considered to be a first optical path through the waveguide 900, the fifth trajectory 916, the sixth trajectory 918, and the seventh trajectory 920 are considered to be a second optical path through the waveguide 900, and the eighth trajectory 924 and the ninth trajectory 926 are considered to be a third optical path through the waveguide 900. Here, the first optical path, the second optical path, and the third optical path are each different from one another. For example, at least some of the propagation angles of the first portion of display light 911 as it travels along the trajectories of the first optical path are different from otherwise corresponding propagation angles of the second portion of display light 915 as it travels along trajectories of the second optical path and are different from otherwise corresponding propagation angles of the third portion of display light 925 as it travels along trajectories of the third optical path.

Each time the trajectory of display light (e.g., the display light 906, the first portion of display light 911, the second portion of display light 915, the third portion of display light 925) within the waveguide 900 changes (e.g., due to incidence on a diffraction grating, such as the incoupler 214, the first exit pupil expander 902, the second exit pupil expander 904, or the outcoupler 216), some image information of a portion of the image conveyed by that light is at least partially lost, while the remainder of the image is substantially preserved. For example, the portions of the image that are preserved is correspond to the portions of the display light that propagate at propagation angles for which TIR is achievable through the waveguide 900, while the portions of the image that are not fully preserved (i.e., for which image information is partially lost) correspond to the portions of display light that propagate at any other propagation angle. Because the first portion of display light 911, the second portion of display light 915, and the third portion of display light 925 each travel through the waveguide 900 along respectively different optical paths with respectively different propagation angles, the preserved portions of the first image carried by the first portion of display light 911, the preserved portions of the second image carried by the second portion of display light 915, and the preserved portions of the third image carried by the third portion of display light 925 are each different from one another. Thus, in some embodiments, the final image output via the outcoupler 216 has a higher spatial or angular resolution than any one of the first image, the second image, or the third image alone.

In some embodiments, the first portion of display light 911 that conveys the first image utilizes a first set of optical modes, the second portion of display light 915 that conveys the second image utilizes a second set of optical modes, and the third portion of display light 925 utilizes a third set of optical modes. The first portion of display light 911, the second portion of display light 915, and the third portion of display light 925 traverse spatially distinct paths. That is, the first set of optical modes and the second set of optical modes are respectively non-overlapping or partially non-overlapping, with each of the first and second sets of optical modes corresponding to respectively different portions of the original image. In this way, the density of optical modes of utilized to convey the final image are increased, compared that of the optical modes utilized to convey the first image alone or those utilized to convey the second image alone (e.g., compared to a waveguide that only includes one of the first or second optical paths).

By redirecting the display light 906 through the waveguide 900 via multiple optical paths, therefore, the spatial or angular resolution of images conveyed via the waveguide 900 is advantageously increased. Further, by providing the third portion of display light 925 directly from the incoupler 214 to the outcoupler 216 without an intervening structure (e.g., exit pupil expander or other diffraction grating), there are fewer changes in the propagation angle of the third portion of display light 925 as it traverses the waveguide 900, resulting in fewer shifts of the third image in k-space and, therefore, a greater portion of the original image (or, in some embodiments, a greater portion of the region of the original image to which the third image corresponds) is retained in the third image than in the first and second images.

In some embodiments, the propagation length along the third optical path is shorter than either of the propagation lengths along the first and second optical paths, such that the third portion of display light 925 that propagates along the third optical path undergoes less scattering (e.g., due to surface or bulk material features or non-idealities) than the first and second portions of the display light 911 and 915 that propagate along the first and second optical paths, which further enhances the respective spatial or angular resolutions of the third image and the corresponding portion of the final image. In some embodiments, the arrangement of the present example enhances the spatial or angular resolution of a targeted region of the field of view (FOV) of the display device, corresponding to a portion of the final image output by the waveguide.

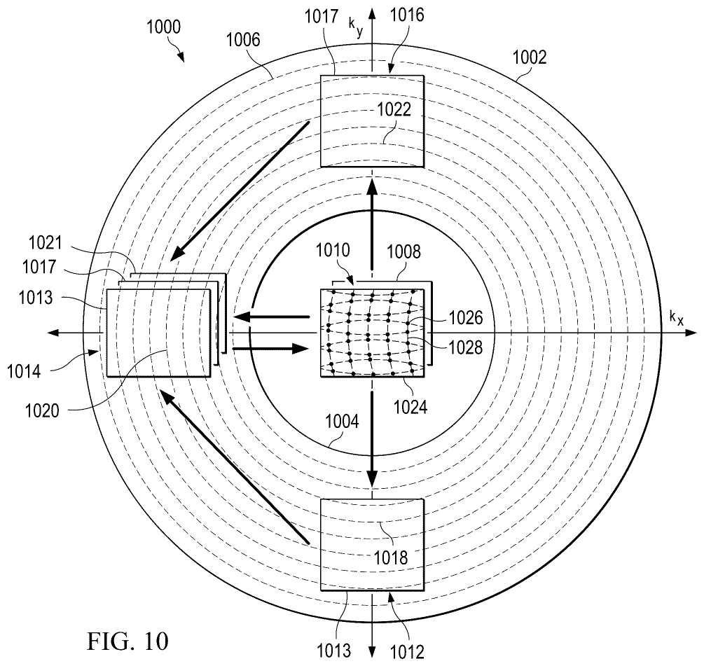

FIG. 10 shows a chart 1000 representing propagation of display light through the waveguide 900 of FIG. 9 with respect to k-space. That is, the chart 1000 is a k-space chart corresponding to a two-dimensional (2D) generalization of the waveguide 900. Accordingly, some aspects of the present example are described with respect to the waveguide 900 and elements thereof.

For light of a given wavelength A in a material with a bulk refractive index of n, the propagation vector for light traveling through the waveguide 900 will have a total magnitude k=(2πn)/A. A given propagation angle in 2D k-space is represented as a circle, requiring k²=kₓ²+k_{y}². Only light traveling at propagation angles between a first boundary angle 1002 and a second boundary angle 1004 is able to propagate along the waveguide 900 via TIR. Further, only light traveling at discrete propagation angles (i.e., discrete polar angles), represented by lines 1006 (dashed circles located between the first boundary angle 1002 and the second boundary angle 1004) is able to propagate along the waveguide 900 via TIR. The lines 1006 are sometimes referred to herein as “propagation angles 1006”.

Initially, the display light 906 entering the waveguide 900 at the incoupler 214 is centered at or around the origin of the chart 1000. Here, an original image 1008 represents an image carried by the display light 906. The original image 1008 is initially disposed at a first position 1010 with respect to k-space when entering the waveguide 900 along the first trajectory 908. Upon redirection of the display light 906 by the incoupler 214, the original image is divided into a first image 1017 conveyed by the first portion of display light 911, a second image 1013 conveyed by the second portion of display light 915, and a third image 1021 conveyed by the third portion of display light 925. Upon redirection of the first portion of display light 911 by the incoupler 214, the first image 1017 is shifted in k-space to a second position 1016, corresponding to a shift in the positive k_{y} dimension. Upon redirection of the second portion of display light 915 by the incoupler 214, the second image 1013 is shifted in k-space to a third position 1012, corresponding to a shift in the negative k_{y} dimension. Upon redirection of the third portion of display light 925 by the incoupler 214, the third image 1021 is shifted in k-space to a fourth position 1014, corresponding to a shift in the negative kₓ dimension. Upon redirection of the first portion of display light 911 by the first exit pupil expander 902, the first image 1017 is shifted in k-space to the fourth position 1014, corresponding to a shift in the negative k_{y} dimension and the negative kₓ dimension. Upon redirection of the second portion of display light 915 by the second exit pupil expander 904, the second image 1013 is shifted in k-space to the fourth position 1014, corresponding to a shift in the positive k_{y} dimension and the negative kₓ dimension. Upon redirection of the first portion of display light 911, the second portion of display light 915, and the third portion of display light 925 by the outcoupler 216, the first image 1017 and the second image 1013, and the third image 1021 are combined to form a final image 1024, and the final image 1024 is shifted in k-space back to the first position 1010, corresponding to a shift in the positive kₓ dimension.

In some embodiments, the first image 1017 and the second image 1013 are each a representation of the original image 1008. In some embodiments, the first image 1017 corresponds to a first spatial portion of the original image 1008, the second image 1013 corresponds to a second spatial portion of the original image 1008. In certain embodiments, the first and second spatial portions of the original image 1008 partially overlap. In some embodiments, the first image 1017 corresponds to a first representation of the original image 1008 that includes only a first set of wavelengths of display light (i.e., colors) of the original image 1008, the second image 1013 corresponds to a second representation of the original image 1008 that includes only a second set of wavelengths of display light (i.e., colors) of the original image 1008, and the first set of wavelengths of display light is different from the second set of wavelengths of display light.

In the present example, it is assumed that the angle at which the display light 906 enters the waveguide 900 via the incoupler 214 is the same as or substantially the same as (e.g., within 5% of) the angle at which the first portion of display light 911, the second portion of display light 915, and the third portion of display light 925 exit the waveguide 900 via the outcoupler 216. At the second position 1016, only the display light that conveys the portions of the first image 1017 overlapped by lines 1022 (corresponding to portions of a subset of the lines 1006) is able to successfully propagate along the waveguide 900 via TIR. At the third position 1012, only the display light that conveys the portions of the second image 1013 overlapped by lines 1018 (corresponding to portions of a subset of the lines 1006) is able to successfully propagate along the waveguide 900 via TIR. At the fourth position 1014, only the display light that conveys the portions of the first image 1017, the second image 1013, and the third image 1021 overlapped by lines 1020 (corresponding to portions of a subset of the lines 1006) is able to successfully propagate along the waveguide 900. Thus, the final image 1024 returns to the first position 1010 (due to shifting and combining of the first image 1017, the second image 1013, and the third image 1021 at the outcoupler 216) upon being redirected out of the waveguide 900.

Only portions of the original image 1008 corresponding to discrete intersections 1026 and those portions corresponding to lines 1028 (e.g., corresponding to the lines 1020) are preserved (i.e., light that conveys these portions of the first and second images 1017 and 1013 successfully propagates through the waveguide 900), in the present example. For example, the intersections 1026 include intersections of the lines 1022 and the lines 1020 from the first image 1017 and intersections of the lines 1018 and the lines 1020 from the second image 1013 (these intersections corresponding to the points at which the corresponding lines would intersect if overlapped as shown). The lines 1028 correspond to the portions of the third image 1021 that are overlapped by the lines 1020. Other portions of the original image 1008 that do not correspond to the discrete intersections 1026 or the lines 1028 are not fully propagated through the waveguide 900 and corresponding image information is at least partially lost. The lines 1028 each represent a respectively different region of viewing angles, where the shape of a given region of viewing angles corresponds to an area of the third image 1021 overlapped by the lines 1020 at the fourth position 1014. In some embodiments, each of the intersections 1026 corresponds to a respectively different subregion of one of the regions of viewing angles represented by the lines 1028.

Since the third portion of display light 925 that conveys the third image 1021 travels directly to the outcoupler 216 from the incoupler 214 via TIR without incidence on an intervening diffraction grating (e.g., exit pupil expander), the portions of the third image 1021 that is overlapped by the lines 1020 are preserved. For example, a greater amount of the third image 1021 is preserved when the third portion of display light 925 propagates through the waveguide 900 along the third optical path, than the amounts of the first image 1017 and the second image 1013 that are preserved due to the absence of an intervening diffraction grating (e.g., exit pupil expander) in the optical path of the third portion of display light 925 between the incoupler 214 and the outcoupler 216. Image information of the original image 1008 corresponding to the portions of the first image 1017, the second image 1013, and the third image 1021 that are not preserved undergoes more loss than image information than image information of the original image 1008 corresponding to the portions of the first image 1017, the second image 1013, and the third image 1021 that are preserved, since the display light that conveys the unpreserved image portions does not successfully propagate through the waveguide 900 via TIR. The spatial or angular resolution of the final image 1024 corresponds to the quantity and density of the discrete intersections 1026 and the lines 1028. That is, the spatial or angular resolution of the final image 1024 corresponds to how much of the original image 1008 is retained after the corresponding light (e.g., the first portion of display light 911, the second portion of display light 915, and the third portion of display light 925) propagates through the waveguide 900.

A first set of intersections of the intersections 1026 corresponds to intersections of the lines 1022 and the lines 1020 from the first image 1017 and a second set of intersections of the intersections 1026 corresponds to the intersections of the lines 1018 and the lines 1020 from the second image 1013. As shown, the first set of intersections is spatially separated from the second set of intersections. In some embodiments, the final image 1024 includes a greater amount of the original image 1008 than is included in either the first image 1017 or the second image 1013 individually. In some embodiments, the brightness of the final image 1024 is greater at the intersections 1026 than at corresponding locations (corresponding portions of the lines 1028) of the third image 1021. Thus, by dividing the display light 906 into the first portion of display light 911, the second portion of display light 915, and the third portion of display light 925 and propagating the first portion of display light 911, the second portion of display light 915, and the third portion of display light 925 through the waveguide 900 via three different optical paths with different propagation angles, the density and quantity of intersections/optical modes of the final image 1024 is advantageously increased, such that the spatial or angular resolution of the final image 1024 is increased (e.g., compared to the output image 408 of FIG. 4).

It should be noted that the number of propagation angles 1006 that allow light to successfully propagate through the waveguide 900 via TIR is typically greater than that shown in the present example and, accordingly, the number of discrete intersections 1026 and lines 1028 in the final image 1024 would be greater than that shown in such instances. That is, reduced quantities of propagation angles 1006, intersections 1026, and lines 1028 are shown in the present example for ease of illustration.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A waveguide comprising:
an incoupler configured to:
receive display light representative of an image for display; and
direct a first portion of the display light to propagate within the waveguide along a first optical path and a second portion of the display light to propagate within the waveguide along a second optical path, wherein the first optical path and the second optical path have substantially non-overlapping propagation angles; and
an outcoupler configured to combine the first portion of the display light and the second portion of the display light to display a representation of the image.

2. The waveguide of claim 1, wherein the first portion of the display light corresponds to a first spatial portion of the image, and wherein the second portion of the display light corresponds to a second spatial portion of the image.

3. The waveguide of claim 2, wherein the first spatial portion of the image and the second spatial portion of the image partially overlap.

4. The waveguide of claim 1, wherein the first portion of the display light comprises a first set of wavelengths, and wherein the second portion of the display light comprises a second set of wavelengths that is distinct from the first set.

5. The waveguide of claim 1, wherein the waveguide comprises:
a first exit pupil expander disposed in the first optical path and configured to redirect the first portion of the display light toward the outcoupler; and
a second exit pupil expander disposed in the first optical path and configured to redirect the second portion of the display light toward the outcoupler.

6. The waveguide of claim 1, wherein the outcoupler is configured to combine the first portion of the display light and the second portion of the display light to display the representation.

7. The waveguide of claim 1, wherein the incoupler is further configured to:
receive the display light from an optical engine;
divide the display light into at least the first portion of the display light and the second portion of the display light;
redirect the first portion of the display light to propagate within the waveguide along the first optical path; and
redirect the second portion of the display light to propagate within the waveguide along the second optical path.

8. The waveguide of claim 7, wherein the incoupler is further configured to divide the display light into a third portion of the display light, and to direct the third portion of the display light to propagate along a third optical path that is distinct from the first optical path and the second optical path.

9. The waveguide of claim 8, wherein the representation is a combination of the first portion of the image, the second portion of the image, and the third portion of the image.

10. A method, comprising:
receiving display light representative of an image for display;
directing a first portion of the display light to propagate within a waveguide along a first optical path and a second portion of the display light to propagate within the waveguide along a second optical path, the first optical path and the second optical path having respectively non-overlapping propagation angles; and
combining the first portion of the display light and the second portion of the display light to display a representation of the image.

11. The method of claim 10, wherein the first portion of the display light conveys a first spatial portion of the image, and wherein the second portion of the display light conveys a second spatial portion of the image.

12. The method of claim 11, wherein the first spatial portion of the image and the second spatial portion of the image partially overlap.

13. The method of claim 10, wherein directing the first portion of the display light along the first optical path includes directing a first set of wavelengths of the display light along the first optical path, wherein directing the second portion of the display light along the second optical path includes directing a second set of wavelengths of the display light along the second optical path, and wherein the second set of wavelengths is distinct from the first set.

14. The method of claim 10, further comprising:
redirecting the first portion of the display light toward an outcoupler of the waveguide with a first exit pupil expander disposed in the first optical path; and
redirecting the second portion of the display light toward the outcoupler with a second exit pupil expander disposed in the second optical path.

15. The method of claim 14, further comprising combining, with the outcoupler, the first portion of the display light and the second portion of the display light to display the representation.

16. The method of claim 10, comprising:
receiving, with an incoupler of the waveguide, the display light from an optical engine;
dividing, by the incoupler, the display light into at least the first portion of the display light and the second portion of the display light;
redirecting, by the incoupler, the first portion of the display light to propagate within the waveguide along the first optical path; and
redirecting, by the incoupler, the second portion of the display light to propagate within the waveguide along the second optical path.

17. The method of claim 10, further comprising dividing the display light into a third portion and directing the third portion of the display light to propagate along a third optical path that is distinct from the first optical path and the second optical path.

18. The method of claim 17, further comprising displaying the representation by combining the first portion of the display light, the second portion of the display light, and the third portion of the display light.

19. A projection system comprising:
an optical engine; and
a waveguide configured to:
receive display light representative of an image for display;
direct a first portion of the display light to propagate within the waveguide along a first optical path and a second portion of the display light to propagate within the waveguide along a second optical path, wherein the first optical path and the second optical path have respectively non-overlapping propagation angles; and
combine the first portion of the display light and the second portion of the display light to display a representation of the image.

20. The projection system of claim 19, wherein the waveguide is further configured to divide the display light into a third portion, and to direct the third portion of the display light to propagate along a third optical path that is distinct from the first optical path and the second optical path.
